(19) United States
(12) Patent Application Publication
(10) Pub. No.: US 2025/0210289 A1
(43) Pub. Date: Jun. 26, 2025

(54) TEMPERATURE CONTROL SWITCH

(71) Applicant: DongGuan SAFETY Electronic SCI & Tech Co; Ltd, Dongguan (CN)

(72) Inventor: Xuewu YAO, Wugang (CN)

(21) Appl. No.: 18/391,110

(22) Filed: Dec. 20, 2023

(51) Int. Cl. H01H 37/52; H01H 37/64

(52) U.S. Cl. CPC H01H 37/52; H01H 37/64

(57) ABSTRACT

A temperature control switch includes a ceramic base. A bimetal sheet body is positioned on an upper end of the ceramic base. An upper end of the bimetal sheet body is provided with a bimetal sheet insulation film. An upper end of the bimetal sheet insulation film is provided with a first static contact plate. A surface of an upper end of the first static contact plate is provided with a stationary contact. An upper end of the first static contact plate is provided with a first spring plate. A bottom end of the first spring plate is provided with a movable contact. A spring plate insulation film is arranged between the first spring plate and the first static contact plate. The upper end of the first spring plate is provided with a ceramic upper cover. Through holes are located inside the ceramic upper cover.

### TECHNICAL FIELD

This invention belongs to the technical field of temperature control switch, and it concretely involves a temperature control switch.

### BACKGROUND OF THE DISCLOSURE

Temperature control switch generally refers to thermostat, which means a series of automatic control element, according to the temperature change in the working environment, physical deformation occurs inside switch to produce certain special effect, it has conduction or disconnection action, and it is also called temperature control switch, temperature protector or temperature controller, which can be called thermostat for short. Or temperature is transmitted to the temperature controller through temperature protector, the temperature controller issues switch command, so as to control the operation of equipment to reach ideal temperature and energy-saving effect.

Encapsulation of existing temperature control switch is inconvenient, the universality of equipment is low and its use-cost is high, and it is unavailable for using in ordinary high temperature environment and ultra-high temperature environment.

### SUMMARY OF THE DISCLOSURE

In order to solve the problem put forward in the above-mentioned prior art, a temperature control switch is provided in this invention, and it has the features of good high temperature resistance by its ceramic encapsulation and high universality by its plastic encapsulation.

To achieve the above purpose, the following technical scheme is provided in this invention: A temperature control switch that includes ceramic base, on which there is main body of bimetal sheet, there is insulation film of bimetal sheet on the upper end of the main body of bimetal sheet, there is static contact plate (1) on the upper end of the insulation film of bimetal sheet, there is stationary contact on the surface of upper end of static contact plate (1), there is spring plate (1) on the upper end of static contact plate (1), there is movable contact at the bottom end of spring plate (1) corresponding to the stationary contact, there is insulation film of spring plate between spring plate (1) and static contact plate (1), there is ceramic upper cover on the upper end of spring plate (1), there is through hole at four corners inside the ceramic upper cover, there is rivet inside the through hole, and there is locating hole inside the ceramic base corresponding to rivet.

Preferably, plastic base can also be set below the said main body of bimetal sheet, there is fastening plastic column at four corners on the upper end of plastic base, static contact plate (2) can also be set on the upper end of the insulation film of bimetal sheet, there is stationary contact on the surface of static contact plate (2), there is spring plate (2) on the upper end of the static contact plate (2), there is movable contact on the bottom end of spring plate (2) corresponding to the stationary contact, there is plastic upper cover on the upper end of spring plate (2), and there is fusion hole inside the plastic upper cover corresponding to the fastening plastic column.

Preferably, the interiors of the said ceramic base and plastic base are both hollow out design, and there is placing slot inside the ceramic base and plastic base corresponding to the main body of bimetal sheet.

Preferably, there is installation block at the middle position of bottom end of the said ceramic upper cover and plastic upper cover.

Preferably, there is positioning slot symmetrically inside the said ceramic upper cover and plastic upper cover, and the positioning slot respectively corresponds to the protruding part of spring plate (1) and static contact plate (1) as well as spring plate (2) and static contact plate (2).

Compared with existing techniques, the advantageous effect of this invention is:

Against the problem of the main body of temperature control switch being highly affected by high temperature in working environment after working power off, this invention solves it in an all-round way for application in high temperature environment, so as to ensure no failure of product caused by overall deformation of temperature control switch under ultra-high temperature, as a result, the service life of equipment is improved, the working strength of product is guaranteed, and when temperature control switch is used under ordinary high temperature status, hot melting can be adopted for making the fastening plastic column deform, so as to combine together the upper cover and the base by clasping, the encapsulation can be reduced and the using convenience of equipment can be improved.

### BRIEF DESCRIPTION OF THE DRAWINGS

FIG. 1 is the space diagram for the ceramic shell structure of this invention;

FIG. 2 is the front view for the ceramic shell structure of this invention;

FIG. 3 is the space diagram for the plastic shell structure of this invention;

FIG. 4 is the front view for the plastic shell structure of this invention.

In the drawings: 1. Ceramic upper cover; 2. Rivet; 3. Through hole; 4. Spring plate (1); 5. Insulation film of bimetal sheet; 6. Main body of bimetal sheet; 7. Ceramic base; 8. Locating hole; 9. Movable contact; 10. Stationary contact; 11. Static contact plate; 12. Insulation film of spring plate; 13. Spring plate; 14. Static contact plate; 15. Fastening plastic column; 16. Fusion hole; 17. Plastic upper cover; 18. Plastic base.

### DETAILED DESCRIPTION OF THE DISCLOSURE

Combined with the patent drawing in the example of this invention, the technical scheme in the example of this invention is then described clearly and completely, the example described here is obviously only part examples instead of all examples of this invention. For all other examples obtained by ordinary technical personnel in this field on the basis of the example in this invention, so long as those examples are obtained on the prerequisite of not making creative labor, they belong to the scope protected by this invention.

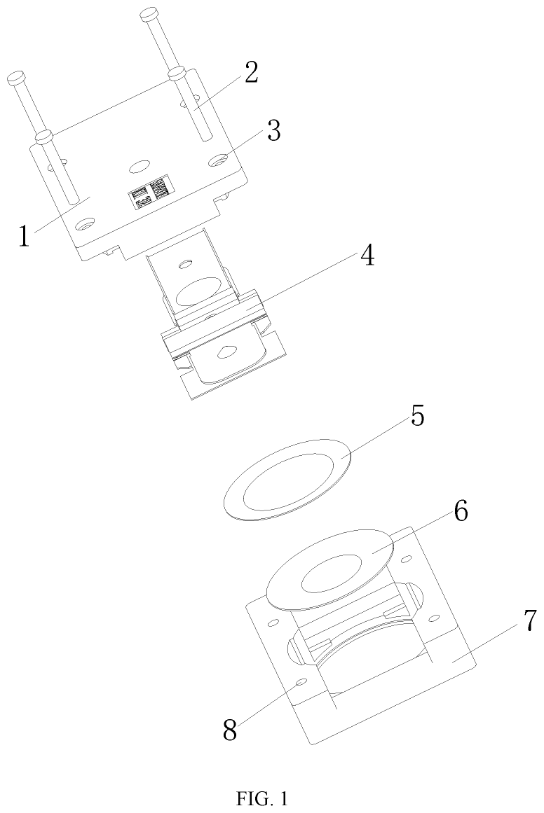

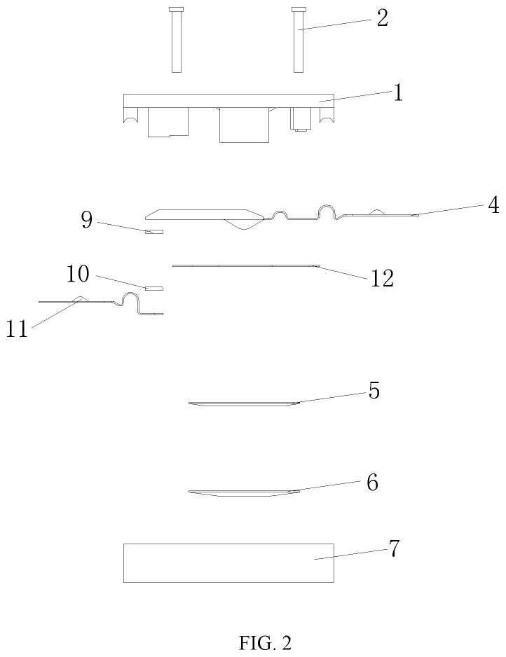

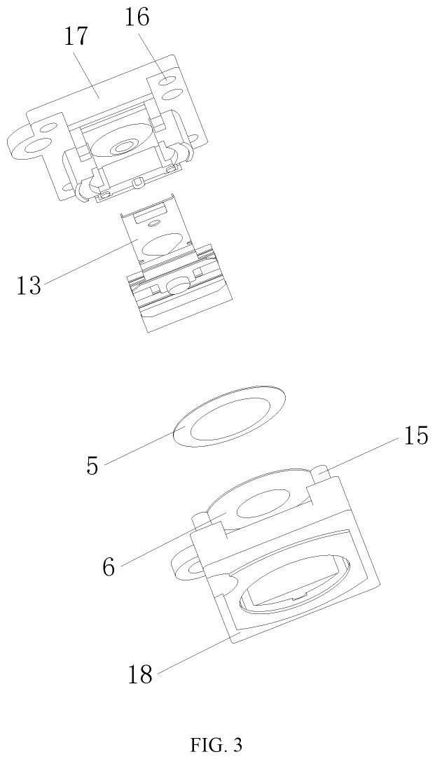

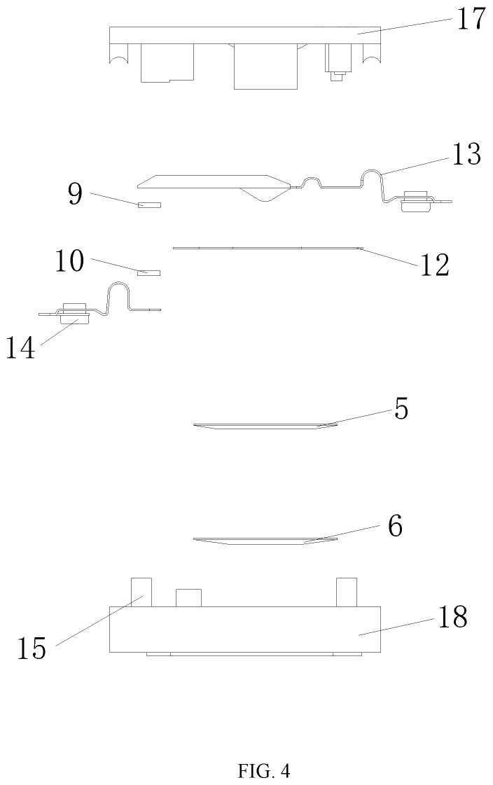

Please refer to FIGS. 1-4, the following technical scheme is provided by this invention: a temperature control switch that includes ceramic base 7, on which 7 there is main body 6 of bimetal sheet, there is insulation film of bimetal sheet 5 on the upper end of the main body 6 of bimetal sheet, there is static contact plate (1) 11 on the upper end of the insulation film of bimetal sheet 5, there is stationary contact 10 on the surface of upper end of static contact plate (1) 11, there is spring plate (1) 4 on the upper end of static contact plate (1) 11, there is movable contact 9 at the bottom end of spring plate (1) 4 corresponding to the stationary contact 10, there is insulation film 12 of spring plate between spring plate (1) 4 and static contact plate (1) 11, there is ceramic upper cover 1 on the upper end of spring plate (1) 4, there is through hole 3 at four corners inside the ceramic upper cover 1, there is rivet 2 inside the through hole 3, and there is locating hole 8 inside the ceramic base 7 corresponding to rivet 2.

Concretely, plastic base 18 can also be set below the main body 6 of bimetal sheet, there is fastening plastic column 15 at four corners on the upper end of plastic base 18, static contact plate (2) 14 can also be set on the upper end of the insulation film of bimetal sheet 5, there is stationary contact 10 on the surface of static contact plate (2) 14, there is spring plate (2) 13 on the upper end of the static contact plate (2) 14, there is movable contact 9 on the bottom end of spring plate (2) 13 corresponding to the stationary contact 10, there is plastic upper cover 17 on the upper end of spring plate (2) 13, and there is fusion hole 16 inside the plastic upper cover 17 corresponding to the fastening plastic column 15.

By adopting the above-mentioned technical scheme, when temperature control switch is used under ordinary high temperature circumstance, the fusion hole 16 inside the plastic upper cover 17 is correspondingly spliced with the fastening plastic column 15 on the surface of plastic base 18, the fastening plastic column 15 through hot melting shall deform to be combined together with the plastic upper cover 17 by clasping, so as to guarantee the convenience of equipment encapsulation, reduce the encapsulation cost and improve the using efficiency.

Concretely, the interiors of the said ceramic base 7 and plastic base 18 are both hollow out design, and there is placing slot inside the ceramic base and plastic base corresponding to the main body of bimetal sheet. There is placing slot inside the ceramic base 7 and plastic base 18 corresponding to the main body 6 of bimetal sheet.

By adopting the above technical scheme, the sensitivity of the main body 6 of bimetal sheet to temperature sensing is improved, and the precision of temperature control is improved.

Concretely, there is installation block at the middle position of bottom end of the ceramic upper cover 1 and plastic upper cover 17.

By adopting the above technical scheme, the installation of the spring plate (1) 4 and static contact plate (1) 11 as well as spring plate (2) 13 and static contact plate (2) 14 are guaranteed to be stable and firm, so as to improve the using quality of equipment and improve the working effect.

Concretely, there is positioning slot symmetrically inside the said ceramic upper cover 1 and plastic upper cover 17, and the positioning slot respectively corresponds to the protruding part of spring plate (1) 4 and static contact plate (1) 11 as well as spring plate (2) 13 and static contact plate (2) 14.

By adopting the above technical scheme, normal working of the spring plate (1) 4 and static contact plate (1) 11 as well as spring plate (2) 13 and static contact plate (2) 14 can be guaranteed, and the stability of disconnection and connection of the movable contact 9 and stationary contact 10 can be ensured.

The working principle and using process of this invention: when this invention is used, when the temperature control switch is used in high temperature environment, the ceramic upper cover 1 and ceramic base 7 shall be encapsulated, spring plate (1) 4 and static contact plate (1) 11 shall be installed to the interior of ceramic upper cover 1, the insulation film of bimetal sheet 5 and the main body 6 of bimetal sheet shall be put into the placing slot inside the ceramic base 7, then the ceramic upper cover 1 and ceramic base 7 shall be spliced, meanwhile, rivet 2 shall be used pass through the through hole 3 inside the ceramic base 7 and fixed to the interior of locating hole 8, then it shall directly contact the heat source through the main body 6 of bimetal sheet, so that it shall act rapidly when it meets the setting of operating temperature, movable contact 9 and stationary contact shall be disconnected or connected through action of spring plate (1) 4 and static contact plate (1) 11, and when temperature drops to the setting of resetting temperature, the main body 6 of bimetal sheet shall quickly restore its original shape, the movable contact 9 and stationary contact 10 shall be connected or disconnected, so as to reach the purpose of connecting or disconnecting the electric circuit, the electric circuit is controlled to guarantee the using performance of temperature control switch, the product would not fail because of overall deformation caused by ultra-high temperature, so as to improve the service life of equipment;

When the temperature control switch is used under ordinary high temperature circumstance, the fusion hole 16 inside the plastic upper cover 17 is correspondingly spliced with the fastening plastic column 15 on the surface of plastic base 18, and fastening plastic column 15 through hot melting shall deform, and it shall be combined together with the plastic upper cover 17 by clasping, so as to guarantee the convenience of equipment encapsulation, reduce the encapsulation cost and improve the using efficiency.

The example of this invention has been shown and described, but for ordinary technical personnel in this field, it is understood that under the circumstance of not being disengaged from the principle ad spirit of this invention, multiple changes, modifications, substitutions and transformations to those examples are available, and the scope of this invention is restricted by the attached claim and its equivalent.

What is claimed is:

1. A temperature control switch comprising a ceramic base, characterized in that there is main body of bimetal sheet on the upper end of the said ceramic base, there is insulation film of bimetal sheet on the upper end of the main body of bimetal sheet, there is static contact plate (1) on the upper end of the insulation film of bimetal sheet, there is stationary contact on the surface of upper end of static contact plate (1), there is spring plate (1) on the upper end of static contact plate (1), there is movable contact at the bottom end of spring plate (1) corresponding to the stationary contact, there is insulation film of spring plate between spring plate (1) and static contact plate (1), there is ceramic upper cover on the upper end of spring plate (1), there is through hole at four corners inside the ceramic upper cover, there is rivet inside the through hole, and there is locating hole inside the ceramic base corresponding to rivet.

2. The temperature control switch according to claim 1, characterized in that plastic base can also be set below the said main body of bimetal sheet, there is fastening plastic column at four corners on the upper end of plastic base, static contact plate (2) can also be set on the upper end of the insulation film of bimetal sheet, there is stationary contact on the surface of static contact plate (2), there is spring plate (2) on the upper end of the static contact plate (2), there is movable contact on the bottom end of spring plate (2) corresponding to the stationary contact, there is plastic upper cover on the upper end of spring plate (2), and there is fusion hole inside the plastic upper cover corresponding to the fastening plastic column.

3. The temperature control switch according to claim 2, characterized in that the interiors of the said ceramic base and plastic base are both hollow out design, and there is placing slot inside the ceramic base and plastic base corresponding to the main body of bimetal sheet.

4. The temperature control switch according to claim 2, characterized in that there is installation block at the middle position of bottom end of the said ceramic upper cover and plastic upper cover.

5. The temperature control switch according to claim 2, characterized in that there is positioning slot symmetrically inside the said ceramic upper cover and plastic upper cover, and the positioning slot respectively corresponds to the protruding part of spring plate (1) and static contact plate (1) as well as spring plate (2) and static contact plate (2).
